(19) United States
(12) Patent Application Publication
(10) Pub. No.: US 2025/0361902 A1
(43) Pub. Date: Nov. 27, 2025

(54) Instrumented Nut, Tightening Socket, Tightening Device and Method for Tightening Such a Nut

(71) Applicant: LISI AEROSPACE, Paris (FR)

(72) Inventors: Clément ROUSSEAU, Osny (FR); Christophe PAYARD, Rueil-Malmaison (FR)

(73) Assignee: LISI AEROSPACE, Paris (FR)

(21) Appl. No.: 19/205,929

(22) Filed: May 12, 2025

(30) Foreign Application Priority Data
May 24, 2024 (FR) 2405326

(51) Int. Cl. F16B 31/02; B25B 13/06; G01L 1/18; G01L 5/24; G01N 27/02

(52) U.S. Cl. CPC F16B 31/02; B25B 13/06; G01L 1/18; G01L 5/24; G01N 27/02; F16B 2200/93

(57) ABSTRACT

The invention relates to an instrumented metal nut (10b), having a tubular body having a polygonal drive surface (14). The nut comprises, on at least one annular portion (34) of the outer surface: an electrically insulating layer (36), applied to the annular portion; a piezoresistive conductive polymer (38), the ohmic resistance of which varies according to a stress exerted during tightening of the nut on a threaded fastener, said conductive polymer being applied to the electrically insulating layer; and at least two electrodes (40).

The present invention relates to the field of screw tightening and relates, in particular, to an instrumented nut for knowing the stresses present in the screw during and/or after tightening. In particular, the invention relates to an instrumented metal nut, having a tubular body extending along an axis between a first and a second face, the body having a polygonal drive surface.

This application also relates to a socket suitable for tightening said nut and a tightening device for said nut by means of said socket.

In order to achieve optimal tightening of a assembly, it is necessary to optimize the preload of the fasteners used to tighten the assembly. The preload of a fastener is the first tension created in the fastener when it is installed in the assembly. Precise knowledge of the tension installed in the fastener is essential to ensure the durability of the assembly over time, under the effect of external constraints. Indeed, too intense a tightening can deteriorate the screw or the part in which it is screwed, and too little tightening can lead to the screw decoupling from the said part.

Tightening can be carried out using a torque wrench that indicates a tightening torque. However, the tightening torque is not an accurate measure of the preload in the screw, as the screw also depends on the friction coefficients between the threads of the screw and the nut, as well as between the nut and the contact face, which are difficult to control.

It is also known to indirectly determine the preload of a screw by equipping the nut with strain gauges. For example, FR3106634A1 describes a nut with a polygonal drive surface and a base, with the base provided with strain gauges configured to measure a nut strain in the axial direction. The deformation of the nut is indicative of the preload in the screw. However, the gauges are glued, either directly to the body of the nut or to a film which is then glued to said body. Such a system requires a durable adhesive to ensure that the gauges do not peel off over time.

The present invention is intended to remedy some or all of the disadvantages of the prior art.

For this purpose, the invention relates to a nut of the above-mentioned type, comprising, on at least one annular portion of the outer surface: an electrically insulating layer, applied to the annular portion; a piezoresistive conductive polymer, the ohmic resistance of which varies according to a stress exerted during tightening of the nut on a threaded fastener, said conductive polymer being applied to the electrically insulating layer; and at least two electrodes.

The invention makes it possible to precisely adjust a preload in a screw, exerted by a tight threaded fastener, with limited additional cost, reduced additional mass and increased reliability.

Following other advantageous aspects of the invention, the nut has one or more of the following characteristics, taken separately or in all technically possible combinations:
the annular portion of the outer surface is a groove on the outer surface;
the annular portion is a portion of the truncated conical surface adjacent to the drive surface;
the annular portion is a portion of the polygonal drive surface;
each electrode is placed on the conductive polymer;
at least one electrode is remote from the conductive polymer and electrically isolated from the outer surface, each electrode being electrically connected to a contact point on the conductive polymer.

The invention also relates to a socket adapted to tighten the nut, the socket comprising as many electric pins as the nut has electrodes, each electric pin being capable of electrically connecting to an electrode of the nut.

According to an advantageous aspect of the invention, each electric pin is a spring-loaded electric pin.

The invention also relates to a fastener tightening device, said fastener comprising: a nut as described above; and a screw comprising a threaded end capable of cooperating with the nut; the tightening device comprising a socket as described above, said tightening device further comprising a measuring apparatus configured for: send an electric current through at least one electrode of the nut; measure at least one potential difference between the other electrodes of the nut; and calculate a preload value in the screw based on the measured potential differences.

Following an advantageous aspect of the invention, the device is capable of implementing a method for reconstructing the value of the resistivity in the nut by electrical impedance tomography.

The invention will become clearer from the following description, given only as a non-exhaustive example, and made with reference to the drawings in which:

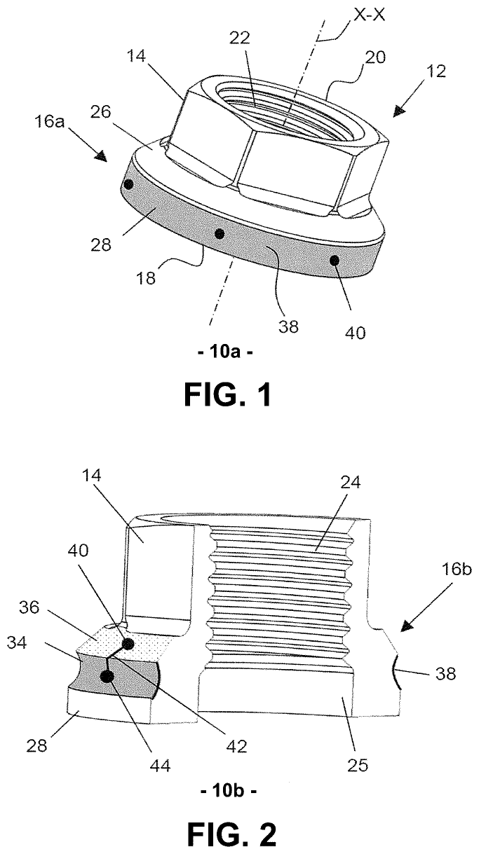

FIG. 1 is an isometric view of a nut illustrating a first embodiment of the invention,

FIG. 2 is an isometric cross-sectional view of a nut illustrating a second embodiment of the invention,

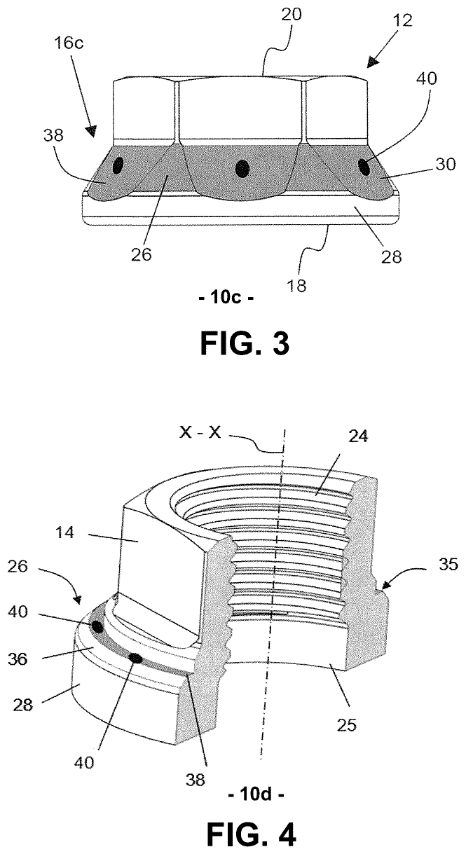

FIG. 3 is an isometric view of a nut illustrating a third embodiment of the invention,

FIG. 4 is an isometric cross-sectional view of a nut illustrating a fourth embodiment of the invention,

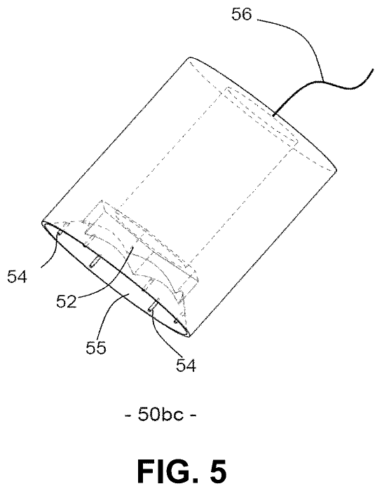

FIG. 5 is an isometric view of a tightening socket capable of tightening the nut in FIGS. 2 and 3,

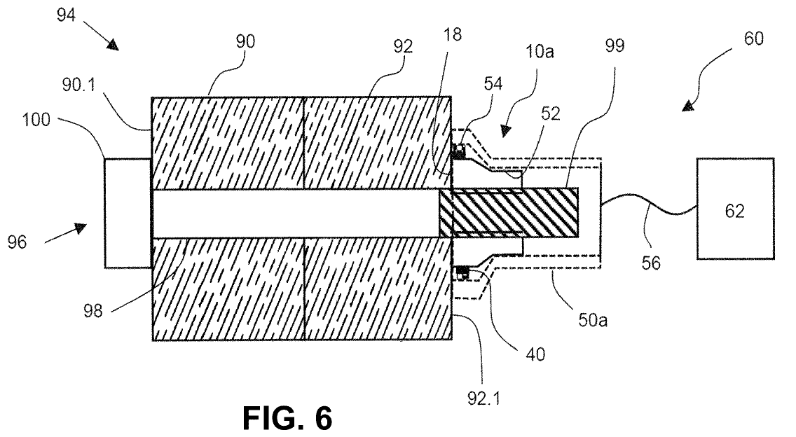

FIG. 6 is a cross-section of an assembly comprising a nut in FIG. 1 coupled to a socket in a second embodiment, and a device for measuring the tension in the nut, and

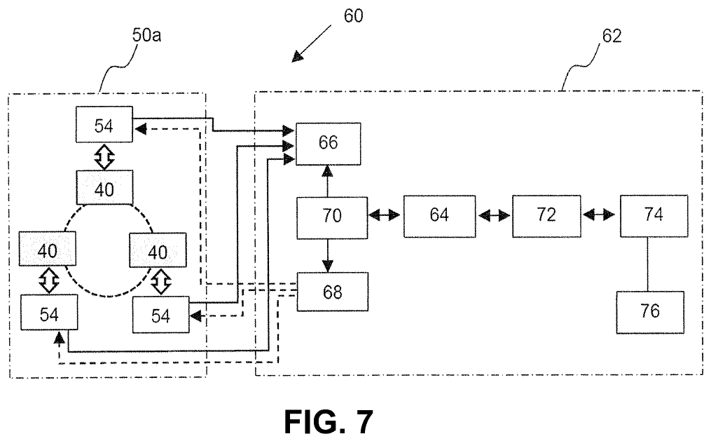

FIG. 7 is a diagram of a nut, a nut tightening device and a device for measuring a strain in the nut illustrating a method of embodiment of the invention.

In the following description, nuts 10a, 10b, 10c and 10d will be described concurrently, with similar nut components designated by the same reference numbers.

The nut 10a, 10b, 10c, 10d is made of metal, for example made of titanium alloy TA6V.

The nut 10a, 10b, 10c, 10d extends along an X-X axis and comprises: a tubular body 12, having a hexagonal drive surface 14; a base 16a, 16b, 16c, 16d; first 18 and second 20 terminal faces; and a through-hole 22, opening at the level of the said first and second terminal faces. The through-hole includes a tapped portion 24 configured to cooperate with the threaded portion of a threaded element such as a screw. The through-hole also includes a counterbore 25, unthreaded and larger in diameter than the largest diameter of the tapped portion 24.

The base 16a, 16b, 16c, 16d includes a truncated conical outer surface 26, adjacent to the hexagonal drive surface 14. Preferably, the base 16a, 16b, 16c, 16d additionally includes a cylindrical outer surface 28, adjacent to the truncated conical outer surface 26 opposite the hexagonal drive surface 14.

In the second embodiment of nut 10b, the cylindrical outer surface 28 of the base 16b includes an annular groove 34.

In the third embodiment of the nut 10c, the base 16c additionally comprises six faces 30 cutting the truncated conical outer surface 26, each face 30 being aligned with a flat surface of the hexagonal drive surface 14.

In the fourth embodiment of the nut 10d, the truncated conical outer surface 26 of the base 16d includes a flat surface, preferably a shoulder 35, intersecting the truncated conical outer surface 26. The shoulder 35 is substantially normal to the X-X axis of the nut 10d. In a variant not shown, the truncated conical outer surface 26 of the base 16d includes an annular groove 34.

Nut 10a, 10b, 10c, 10d has an electrically insulating layer 36 applied to at least a portion of the outer surface of the nut, directly on the bare material, or on an aluminum pigment coating of the HI-KOTE™ type, described for example in document EP2406336. In the examples in FIGS. 1 to 4, the electrically insulating layer 36 is applied: to the cylindrical outer surface 28 of nut 10a; on the truncated conical surface and on a portion of the cylindrical outer surface of nut 10b; on the cut conical surface of the nut 10c, 10d.

Alternatively, the base 16a, 16b, 16c, 16d could be completely covered with insulating layer 36, e.g. by masking the hexagonal drive surface 14 and spraying a solution consisting of a polymer and solvent on the base plate and then evaporating the solvent. An alternative would be to fully dip the nut (without masking) in such a solution. Alternatively, the nut 10a, 10b, 10c, 10d could be anodized to create an insulating oxidation layer on the outer surface.

A conductive polymer 38 is at least partially placed on the electrically insulating layer 36. In the examples of nuts 10a, 10c, the conductive polymer completely covers the electrically insulating layer 36. In the examples of nuts 10b, 10d, the conductive polymer partially covers the electrically insulating layer 36. In the examples of nuts 10b, 10d, the conductive polymer covers only the annular groove 34 and the shoulder 35 respectively.

Conductive polymer 38 is piezoresistive, i.e. its ohmic resistance varies according to the stress exerted when tightening the nut on a threaded fastener. The conductive polymer 38 is conductive enough to allow an electric current to pass through. The conductive polymer is also flexible enough, in order to deform with the nut 10a, 10b, 10c, 10d without cracking when the nut is subjected to deformation, as long as the nut deforms in the elastic range.

Conductive polymer 38 is suitable for electrical impedance tomography. Such a polymer includes conductive nanoparticles, e.g. carbon, silver, copper, iron, nickel nanofibers, etc., and a polymer resin selected from the group consisting of epoxy resins, polyimides, bismaleimides, cyanate esters, polyesters, vinyl esters, and urethanes. Examples of conductive polymers 38 suitable for electrical impedance tomography are described in documents U.S. Pat. No. 5,989,700A and EP1425166B1. The selection of an appropriate polymer resin may be based on exposure to environmental conditions that the nut will experience during its service life once the aircraft is in operation. The nature and amount of conductive particles are preferably chosen to provide a balance between electrical resistance (fewer particles means higher resistance) and viscosity (more particles means higher viscosity).

Electrical Impedance Tomography, abbreviated as EIT, is a technique used mainly in medical imaging to perform non-invasive measurements of electrical conductivity, or on a tissue to identify pressure areas. For example, electrodes are placed on the edges of a tissue, an electric current is injected between two electrodes, one of which is grounded, and the potential in the tissue is measured by all the other electrodes. The current injection is applied successively to the other electrodes to have a set of measurements. From this set of measurements, an image of the electrical conductivity is reconstructed, and via an adapted algorithm called reconstruction, pressure zones in the tissue can be extrapolated. An example of the use of the EIT technique is for example described in the article “EIT-based fabric Pressure Sensing” by A. Yao, C. L. Yang, J. K. Seo, and M. Soleimani, available at http://dx.doi.org/10.1155/2013/405325.

Conductive polymer 38 is arranged on an outer annular surface of the nut.

In the embodiment shown in FIG. 1, the annular surface comprises a cylindrical outer surface 28 of the base. This method of implementation makes it possible to monitor the radial deformation of a counterbore nut, the base plate being less rigid than the rest of the nut.

In the embodiment shown in FIG. 2, the annular surface comprises the annular groove 34 of the base plate 26 of the nut 10b. This method of implementation preserves the integrity of the conductive polymer 38.

In the embodiment of FIG. 3, the annular surface comprises the truncated conical outer surface 26. This method of implementation makes it possible to monitor the bending of the nut. This arrangement is advantageous for nuts with a truncated conical surface that is larger than the cylindrical surface.

In the embodiment shown in FIG. 4, the annular surface comprises the shoulder 35 of the base 26 of the nut 10d. This method of implementation preserves the integrity of the conductive polymer 38.

In another embodiment not shown, an annular groove is arranged on the hexagonal drive surface 14. This method of embodiment, which is advantageous for nuts without a base, also preserves the integrity of the conductive polymer 38.

The nut 10a, 10b, 10c, 10d also has a plurality of electrodes 40. An electrode is the end of an electrical conductor through which an electric current arrives or leaves. For example, 40 electrodes are deposited by printing silver-based ink or by gluing.

Each electrode 40 is put in contact with the polymer conductor 38 to capture variations in the electrical current produced by the deformation of the nut when tightening the nut on a threaded fastener.

The nut 10a, 10b, 10c, 10d comprises at least two 40 electrodes spaced from each other, advantageously diametrically opposed. It should be noted that the more electrodes the nut has, the better the reconstruction of the deformation undergone by the nut.

According to a first embodiment, the electrodes are arranged on the conductive polymer 38. In the examples shown, nut 10a in FIG. 1 consists of six electrodes 40, each arranged opposite the edges between two sides of the hexagonal drive surface 14; nut 10b in FIG. 2 comprises six electrodes 40, each arranged opposite the middle of a section of the hexagonal drive surface 14; the nut 10c in FIG. 3 comprises six electrodes 40 each arranged in the middle of a face 30 of the base 16c; and the nut 10d in FIG. 4 comprises twelve electrodes 40 evenly distributed over the shoulder 35 plane. Other configurations with a different number of electrodes 40 are possible and/or with a different placement of electrodes 40.

The electrodes 40 can be deposited equidistant in the direction of the X-X axis from the width of the annular surface. In variants not shown, the electrodes can be evenly distributed on one edge of the annular surface, or on both edges of the annular surface. In this case, the electrodes 40 can be arranged facing each other or staggered.

The mesh formed by the electrode 40 set is configured to generate electrical signals representative of a deformation of the nut, either in one radial measurement direction if the electrode assembly is placed in the same plane perpendicular to the X-X axis of the nut, or in two directions if the electrodes are placed in two planes perpendicular to the X-X axis of the nut, spaced in the direction X-X.

Alternatively, when the conductive polymer 38 covers a portion of the cylindrical outer surface 28 of the base or annular groove 34, the electrodes 40 are advantageously positioned outside the said cylindrical outer surface or annular groove to facilitate electrical contact with a tightening socket, as will be described later. Each electrode 40 is thus offset from the conductive polymer 38 and electrically isolated from the outer surface of the nut, for example by being positioned on a portion of the electrically insulating layer 36. Each electrode 40 is electrically connected by a track 42 to a contact point 44 on the conductive polymer 38 (FIG. 2).

The electrodes 40 are kept on the nut 10a, 10b, 10c, 10d for the entire life of the nut. Thus, the preload can be controlled, even after the initial tightening of the nut, as long as the nut 10a, 10b, 10c, 10d is installed on a screw.

A socket 50a suitable for driving the rotating nut 10a is shown schematically in FIG. 6. A socket 50bc, suitable for driving the 10b, 10c, 10d nut in rotation, is shown in FIG. 5.

The socket 50a, 50bc includes a hex cross-section inner surface 52 suitable for interfacing with the hex drive surface 14 of the nut to drive the nut 10a, 10b, 10c, 10d in rotation. Obviously, if the nut includes a four-, eight-, ten-, or twelve-point drive surface, the inner surface 52 will be modified accordingly. The socket 50a, 50bc includes pins 54 suitable for electrically connecting to the electrodes 40 of the nut 10a, 10b, 10c, 10d. Preferably, the socket 50a, 50bc has at least as many pins 54 as the nut 10a, 10b, 10c, 10d has electrodes 40.

Advantageously, each pin 54 is a spring pin, also known as a “Pogo pin”, to compensate for any misalignment between the socket 50a, 50bc and the nut 10a, 10b, 10c, 10d.

The pins 54 of the socket 50a, suitable for driving the nut 10a, are arranged on a surface coaxial with the cylindrical outer surface 28 of the nut 10a. The pins 54 of the socket 50bc, suitable for driving the nut 10b, 10c, are arranged on a truncated conical front surface 55, preferably of a complementary shape to the truncated conical outer surface 26 of the nut 10b, 10c.

The socket suitable for driving the nut 10d is identical to the socket 50bc, except that it has twelve pins 54 capable of connecting to the twelve electrodes 40 of the nut 10d. The flat 35 shoulder of the nut 10d is not in contact with the truncated conical frontal surface 55 of the socket, which avoids deforming or damaging the conductive polymer 38.

A cable 56 groups the wires (not shown) connecting each pin 54 to a measuring device 62.

A fastener 94 is considered suitable for forming by nut 10a, 10b, 10c, 10d and by a screw 96. A method of making fastener 94, including nut 10a in FIG. 1, is shown in FIG. 7.

In the embodiment represented, screw 96 comprises: a rod 98, provided with a first threaded end 99, and a head 100 attached to a second end of the rod 98. In a variant not shown, the 98 rod is a stud and the 100 head is formed by a nut screwed to one of the ends of the stud.

The first threaded end 99 of the rod 98 is suitable for cooperating with the threaded portion 24 of the nut 10a, 10b, 10c.

A tightening device 60 of a nut 10a, 10b, 10c, 10d is considered. Said tightening device 60 comprises the socket 50a, 50bc described above and a measuring apparatus 62. A method of construction of the device 60, including the socket 50a described above, is shown in FIG. 7.

The measuring device 62 is configured to control the rotation of the tightening socket, to send an electric current to at least one electrode 40 and to measure at least one potential difference between the other electrodes. Measuring device 62 is also configured to determine a preload value in the screw by reconstructing the local change in resistivity in the nut due to nut deformation, e.g. by applying inverse problem analysis.

The measuring apparatus 62 can thus comprise a controller 64, at least one demultiplexer 66, at least one multiplexer 68, a current source 70, a computer 72, a memory 74 and optionally a display 76.

The controller 64 can include an analog-to-digital converter to sample the signals it receives.

The role of the controller 64 is to control the demultiplexers 66 and the multiplexers 68 in order, on the one hand, to sequentially excite the electrodes 40 in pairs, moving the ground each time, and on the other hand, to measure a potential difference across the other electrodes.

The function of the demultiplexers 66 and multiplexers 68 respectively is the demultiplexing of the excitation signals emitted by the controller 64, and the multiplexing of the measurement signals at the level of the electrodes 40 as described above. The controller 64 is arranged to carry out the excitation according to a TIE excitation scheme in order to induce in the nut 10a, 10b, 10c, 10d a change in electrical resistance at the level of the electrodes 40, said change being characteristic of the deformation undergone by the nut. The current source 70 provides the demultiplexers 66 with the current that is multiplied for the excitation currents. The current source 70 can be continuous, in which case the measuring voltage will be measured simultaneously in electrodes 40, or alternating, in which case the amplitude and offset of the voltage with respect to the alternating current will be measured. Alternatively, demultiplexers and multiplexers could be omitted by using a controller connected directly or indirectly to the electrodes.

By TIE excitation scheme we mean a scheme chosen from:
a neighborhood diagram according to which the excitation current is introduced into neighboring electrodes, and the potential difference is measured successively in the other electrodes, each pair of electrodes being successively used to achieve an excitation,
an opposition scheme whereby the excitation current is introduced into diametrically opposed electrodes, and the potential difference is measured successively in the other electrodes, each pair of electrodes being successively used to achieve an excitation, and
a transverse diagram according to which the excitation current is introduced into electrodes opposite to a fixed axis, and the potential difference is measured successively in the other electrodes, each pair of electrodes being successively used to achieve an excitation.

Regardless of the TIE excitation scheme chosen, the current passing through the nut creates a volume distribution of the electric potential. The potential decreases along the streamline as a function of distance from the active electrodes 40 between which the current is injected. The potential drop per unit length is proportional to the current intensity and the resistance of the nut according to Ohm's law. By measuring the potential drop and knowing the current value, the nut resistance value can then be calculated. The computer 72 can thus include a tomographic reconstruction algorithm that uses the potential differences measured on the surface of the nut to calculate the spatial distribution of resistivity within the nut, and transform this resistivity into tension in the screw. The computer 72 can also include a filtering algorithm to improve the calculated resistivity.

The memory 74 includes one or more TIE excitation schemes, as well as voltage target values associated with different nut references.

Display 76 is typically a screen, which displays either a value or a curve. Display 76 is optional.

A method for installing fastener 94 in an assembly will now be described in relation to FIG. 7.

First, the screw 96 is inserted into a hole in an assembly comprising two structural elements 90 and 92. Said assembly is considered to have a front side 90.1 and a rear face 92.1. The shank 98 passes through the hole, the head 100 rests against the front face 90.1 of the assembly. The first threaded end 99 of rod 98 protrudes from the rear face 92.1 of the assembly.

Next, the nut 10a is positioned on the first threaded end 99 of the rod 98.

Next, the measuring device 62 is connected to the nut by assembling the tightening socket 50a to the nut 10a until the pins 54 contact the electrodes 40.

The controller 64 then activates the rotation of the tightening socket 50a, causing the 10a nut to be screwed onto the first threaded end 99 of the screw. When the end face 18 of the nut 10a contacts the back face 92.1 of the assembly, the tension in the screw, and thus in the nut, increases.

During screwing, the controller 64 sends a current into the electrodes 40 according to the chosen TIE excitation scheme. The computer 72 calculates the tension in the nut in real time, and compares the calculated value to a reference value for the nut 10a stored in memory 74. The value of the calculated voltage, or a curve representing the calculated voltage, may be displayed on the display 76 of the measuring device if the measuring device is equipped with a display.

The controller 64 stops the rotation of the nut when the calculated tension value reaches the reference value. The measuring device 62 is disconnected from the nut, by removing the socket from the nut 10a.

1. An instrumented metal nut (10a, 10b, 10c, 10d) having a tubular body (12) extending along an axis (X-X) between a first face (18) and a second face (20), the body having a polygonal drive surface (14),
characterized in that the nut comprises, on at least one annular portion (26, 28, 34) of the outer surface: an electrically insulating layer (36), applied to the annular portion; a piezoresistive conductive polymer (38), the ohmic resistance of which varies according to a stress exerted during tightening of the nut on a threaded fastener, said conductive polymer being applied to the electrically insulating layer; and at least two electrodes (40).

2. A nut according to claim 1, wherein the annular portion of the outer surface is a groove (34) provided on the outer surface.

3. A nut according to claim 1, wherein the annular portion is a portion of the truncated conical surface (26) adjacent to the polygonal drive surface (14).

4. A nut according to claim 1, wherein the annular portion is a portion of the polygonal drive surface (14).

5. A nut according to claim 1, wherein each electrode (40) is disposed on top of the conductive polymer (36).

6. A nut according to claim 1, wherein at least one electrode (40) is offset from the conductive polymer (38) and electrically isolated from the outer surface, each electrode being electrically connected to a contact point (44) disposed on the conductive polymer (38).

7. A socket (50a, 50bc) for tightening a nut (10a, 10b, 10c, 10d) according to claim 1, said socket being adapted to drive the rotating nut, the socket comprising at least as many electric pins (54) as the nut has electrodes (40), each electric pin (54) being capable of electrically connecting to an electrode (40) of the nut.

8. A socket (50a, 50bc) according to claim 7, wherein each electric pin (54) is a spring-loaded electric pin.

9. A tightening device (60) for a fastener (94), said fastener comprising: a nut (10a, 10, 10c, 10d) according to claim 1; and a screw (98) comprising a threaded end (99) capable of cooperating with the nut; the tightening device comprising a socket (50a, 50bc) according to claim 7, said tightening device further comprising a measuring apparatus (62) configured to: send an electric current through at least one electrode (40) of the nut; measure at least one potential difference between the other electrodes (40) of said nut; and calculate a preload value in the screw based on said measured potential differences.

10. A tightening device (60) according to claim 9, capable of implementing a method for reconstructing the resistivity value in the nut (10a, 10, 10c, 10d) by electrical impedance tomography.
